(19) United States
(12) Patent Application Publication
(10) Pub. No.: US 2020/0288868 A1
(43) Pub. Date: Sep. 17, 2020

(54) STAND

(71) Applicant: FUJITSU CLIENT COMPUTING LIMITED, Kanagawa (JP)

(72) Inventors: Ryohei Sato, Kawasaki (JP); Ikki Tatsukami, Kawasaki (JP); Yuko Hirao, Kawasaki (JP); Frank Müller Augste, Munchen (DE); Albert Jiang, Munchen (DE); Morris Sung, Munchen (DE)

(73) Assignee: FUJITSU CLIENT COMPUTING LIMITED, Kanagawa (JP)

(21) Appl. No.: 16/796,301

(22) Filed: Feb. 20, 2020

(30) Foreign Application Priority Data
Mar. 14, 2019 (JP) 2019-046980

(51) Int. Cl. A47B 97/00; G06F 1/18; A47B 46/00

(52) U.S. Cl. CPC A47B 97/00; A47B 2097/006; A47B 46/00; G06F 1/181

(57) ABSTRACT

A stand includes a base that is attached to a housing of an electronic device and extends between a mounting surface and the housing; and a shelf including a first wall facing the mounting surface, and a second wall extending from the first wall in a first direction crossing the first wall. The shelf is to be movably supported by the base between a first position and a second position. The first position is a position in which the first wall is accommodated in the base and the second wall is adjacent to the housing. The second position is a position in which the first wall protrudes from the first position in a second direction crossing the first direction and the second wall is spaced apart from the housing.

### CROSS-REFERENCE TO RELATED APPLICATIONS

This application is based upon and claims the benefit of priority from Japanese Patent Application No. 2019-046980, filed Mar. 14, 2019, the entire contents of which are incorporated herein by reference.

### FIELD

Embodiments described herein relate generally to a stand.

### BACKGROUND

Conventionally, stands for attachment to the housing of an electronic device are known. Such a stand typically includes a base extending between a mounting surface and the housing, and a shelf extending from the base along the mounting surface.

It may be beneficial to provide a stand of a novel, improved structure with less inconvenience such as smaller installation footprint.

It is thus preferable to provide an improved stand of a novel structure with less inconvenience.

### SUMMARY

According to one aspect of this disclosure, a stand includes a base that is attached to a housing of an electronic device and extends between a mounting surface and the housing; and a shelf including a first wall facing the mounting surface, and a second wall extending from the first wall in a first direction crossing the first wall. The shelf is to be movably supported by the base between a first position and a second position. The first position is a position in which the first wall is accommodated in the base and the second wall is adjacent to the housing. The second position is a position in which the first wall protrudes from the first position in a second direction crossing the first direction and the second wall is spaced apart from the housing.

### BRIEF DESCRIPTION OF THE DRAWINGS

FIG. 1 is a front view of an exemplary housing of an electronic device to which a stand according to one or more embodiments is attached;

FIG. 2 is an exemplary side view of the housing of the electronic device to which the stand of one or more embodiments is attached;

FIG. 3 is an exemplary perspective view of the stand of one or more embodiments;

FIG. 4 is an exemplary perspective view of the stand of one or more embodiments and the housing, as seen from an angle different from the angle in FIG. 3;

FIG. 5 is an exemplary exploded perspective view of the stand of one or more embodiments;

FIG. 6 is an exemplary perspective view of a part of the stand of one or more embodiments, as seen from an angle different from the angle in FIG. 3;

FIG. 7 is an exemplary plan view of the stand of one or more embodiments with a shelf being in a first position; and

FIG. 8 is an exemplary plan view of the stand of one or more embodiments with the shelf being in a second position.

### DETAILED DESCRIPTION

The features of the embodiments described below and functions and effects attained by the features are presented for illustrative purposes only. The embodiments can be implemented by features other than the ones disclosed herein. The embodiments can attain at least one of the effects including derivative effects attained by the features.

Throughout this disclosure, ordinal numbers are used to distinguish parts, components, members, portions, positions, directions, and else, and are not intended to indicate order or priority.

### Embodiments

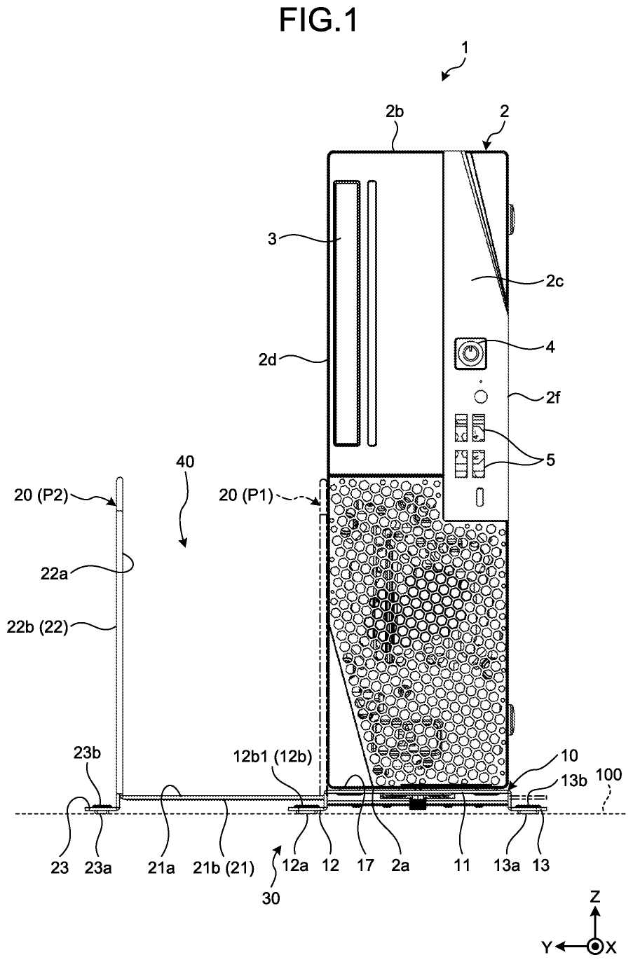

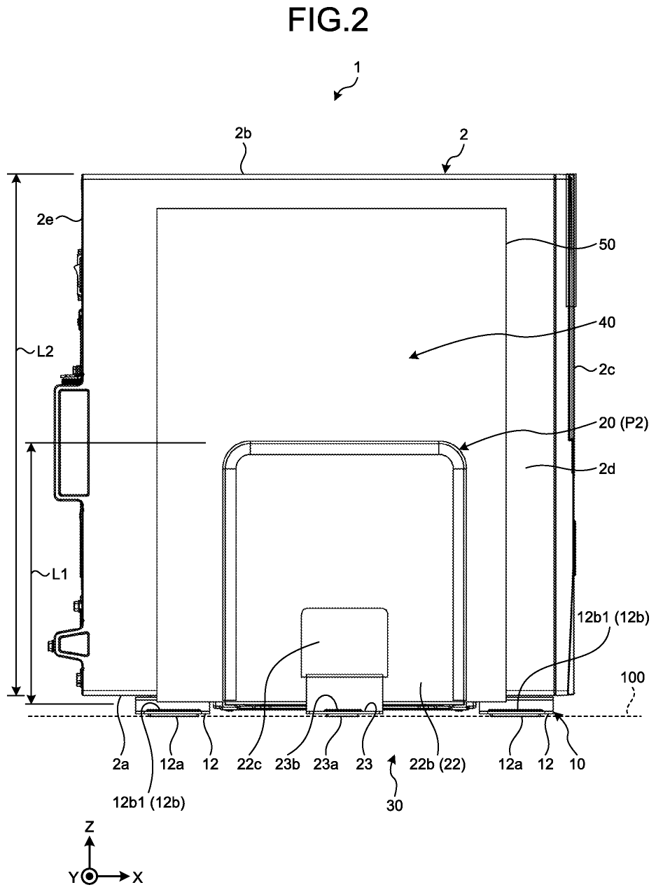

FIG. 1 is a front view of a housing 2 of an electronic device 1 to which a stand 30 according to one or more embodiments is attached, by way of example. FIG. 2 is a side view of the housing 2. As illustrated in FIGS. 1 and 2, the stand 30 is attached to the housing 2 of the electronic device 1 such as a computer tower of a desktop computer, for example. The stand 30 stands between the housing 2 and a mounting surface 100 of, for example, a desk, a counter, or a rack to support the housing 2 upright.

In the following, three orthogonal directions, X-direction, Y-direction, and Z-direction are defined for easier understanding. X-direction is along the depth or in anteroposterior direction of the housing 2 and along the length of the stand 30. Y-direction is along the width (horizontal length) of the housing 2 and along the width (transverse length) of the stand 30. Z-direction is along the height (vertical length) of the housing 2 and along the height (thickness or vertical length)of the stand 30.

The Z-direction is an exemplary first direction crossing the mounting surface 100 (bottom wall 21). The Y-direction is an exemplary second direction crossing the first direction. The X-direction is an exemplary third direction crossing the first direction and the second direction. In the following description, the X-direction may be referred to as a frontward direction. The opposite direction of the X-direction may be referred to as a rearward direction. The Y-direction may be referred to as a leftward direction. The opposite direction of the Y-direction may be referred to as a rightward direction. The Z-direction may be referred to as an upward direction. The opposite direction of the Z-direction may be referred to as a downward direction.

As illustrated in FIGS. 1 and 2, the housing 2 has, for example, a flat, rectangular-cuboid shape in the Y-direction. The housing 2 includes a plurality of walls such as a bottom wall 2a, a top wall 2b, a front wall 2c, a left wall 2d, a rear wall 2e, and a right wall 2f. The bottom wall 2a may be referred to as a lower wall, and the top wall 2b may be referred to as an upper wall. The front wall 2c, the left wall 2d, the rear wall 2e, and the right wall 2f may be referred to as sidewalls or peripheral walls.

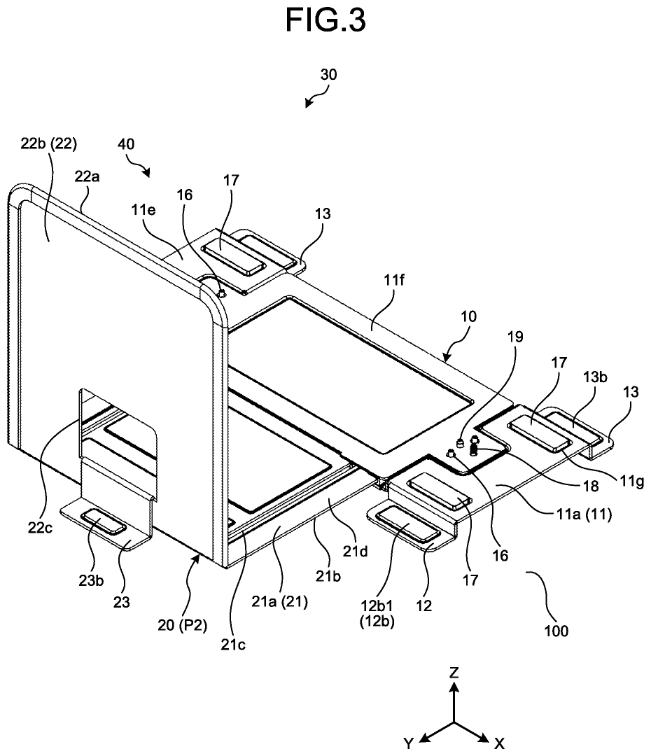

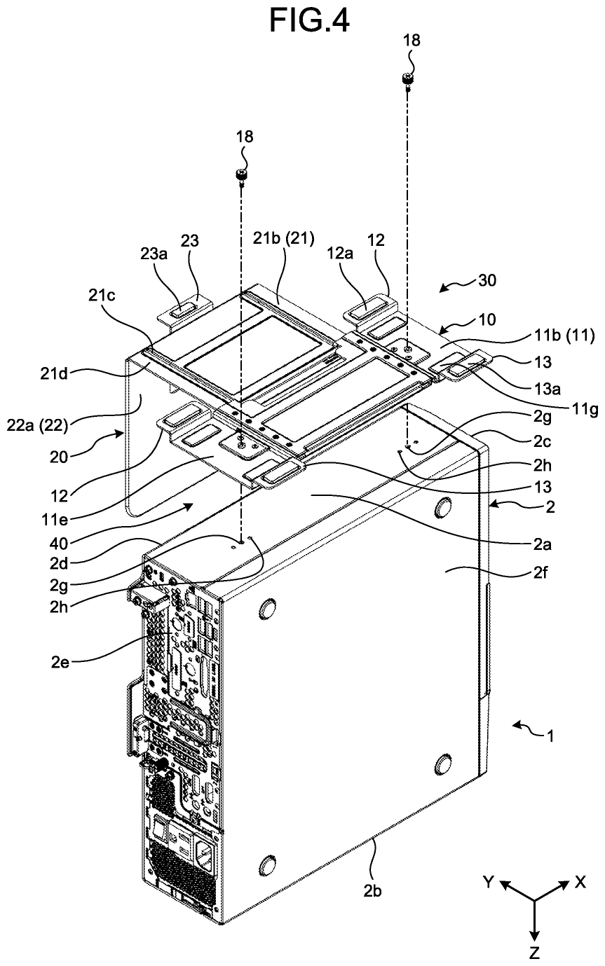

The bottom wall 2a and the top wall 2b extend in a direction orthogonal to the Z-direction, or extend along an XY plane, and are spaced apart in parallel from each other in the Z-direction. The bottom wall 2a serves as the bottom end of the housing 2 and the top wall 2b serves as the top end of the housing 2. The stand 30A includes a base 10, as described later, which is fastened to the bottom wall 2a with fasteners 18 (see FIGS. 3 and 4) such as screws or bolts.

The front wall 2c and the rear wall 2e extend in a direction orthogonal to the X-direction, or extend along an YZ plane, and are spaced apart in parallel from each other in the X-direction. The front wall 2c extends between the X-directional ends of the bottom wall 2a and the top wall 2b. The rear wall 2e extends between the ends of the bottom wall 2a and the top wall 2b in the opposite direction of the X-direction. The front wall 2c serves as the front end of the housing 2 and the rear wall 2e serves as the rear end of the housing 2. The front wall 2c (see FIG. 1) is equipped with, for example, an optical disc drive 3, a power button 4, and connectors 5.

The left wall 2d and the right wall 2f extend in a direction orthogonal to the Y-direction, or extend along an XZ plane, and are spaced apart in parallel from each other in the Y-direction. The left wall 2d extends between the Y-directional ends of the bottom wall 2a and the top wall 2b. The right wall 2f extends between the ends of the bottom wall 2a and the top wall 2b in the opposite direction of the Y-direction. The left wall 2d serves as the left end of the housing 2 and the right wall 2f serves as the right end of the housing 2.

One of the left wall 2d and the right wall 2f faces a shelf 20 of the stand 30, as later described. In one or more embodiments, for example, the left wall 2d (one of the walls) and the shelf 20 define a storage space 40 in which an object 50 (see FIG. 2) such as a book or a file is accommodated or held. The shelf 20 may be referred to as, for example, a book shelf, a book stand, or a book end.

FIG. 3 is a perspective view of the stand 30, and FIG. 4 is a perspective view of the stand 30 and the housing 2, as seen from an angle different from the angle in FIG. 3. As illustrated in FIGS. 3 and 4, the stand 30 includes, for example, the base 10 and the shelf 20. The base 10 is a rectangular plate extending along the bottom wall 2a. The shelf 20 is a substantially L-shaped plate extending along the bottom wall 2a and the left wall 2d.

The base 10 includes, for example, a bottom wall 11 and a plurality of leg plates 12 and 13. The bottom wall 11 is spaced apart from the mounting surface 100 in the Z-direction. The bottom wall 11 has an upper surface 11a (see FIG. 3) in the Z-direction and a lower surface 11b (see FIG. 4) in the opposite direction of the Z-direction. The lower surface 11b faces the mounting surface 100, and the upper surface 11a faces the bottom wall 2a. The bottom wall 11 is an exemplary third wall.

In the four corners of the upper surface 11a, elastic members 17 are placed to elastically support the bottom wall 2a. The elastic members 17 are made of, for example, elastomer or rubber. The elastic members 17 are accommodated in recesses 11g in the bottom wall 11 with at least part of the elastic members 17 protruding to above the upper surface 11a in the Z-direction. The elastic members 17 may be referred to as buffers or cushions.

The leg plates 12 are located at two of the four corners of the bottom wall 11 on the shelf 20 (left wall 2d) side, that is, two Y-directional corners. The leg plates 12 protrude from the bottom wall 11 in the opposite direction of the Z-direction and extend in the Y-direction along the mounting surface 100 with spacing from the bottom wall 11. The leg plates 12 are in contact with the mounting surface 100 and support the bottom wall 11 with spacing from the mounting surface 100. The leg plates 12 are an exemplary fourth wall.

The leg plates 12 are both provided with protrusions 12a (see FIG. 4) protruding in the opposite direction of the Z-direction. The protrusions 12a are made of elastic material such as elastomer or rubber to prevent the leg plates 12 from being abraded or slipping, which may otherwise occur by contacting the mounting surface 100. The protrusions 12a (elastic members) are accommodated in convex-shape chambers 12b (see FIG. 3) protruding from the leg plates 12 in the Z-direction and opening in the opposite direction of the Z-direction.

The leg plates 13 are located at the other two of the four corners of the bottom wall 11 opposite the shelf 20, that is, in the opposite direction of the Y-direction. The leg plates 13 protrude from the bottom wall 11 in the opposite direction of the Z-direction and extend in the opposite direction of the Y-direction along the mounting surface 100 with spacing from the bottom wall 11. The leg plates 13 are in contact with the mounting surface 100 and support the bottom wall 11 with the spacing from the mounting surface 100.

The leg plates 13 are provided with protrusions 13a (see FIG. 4) protruding in the opposite direction of the Z-direction. As with the protrusions 12a, the protrusions 13a are made of elastic material such as elastomer or rubber and are accommodated in chambers 13b (see FIG. 3) protruding from the leg plates 13 in the Z-direction and opening in the opposite direction of the Z-direction.

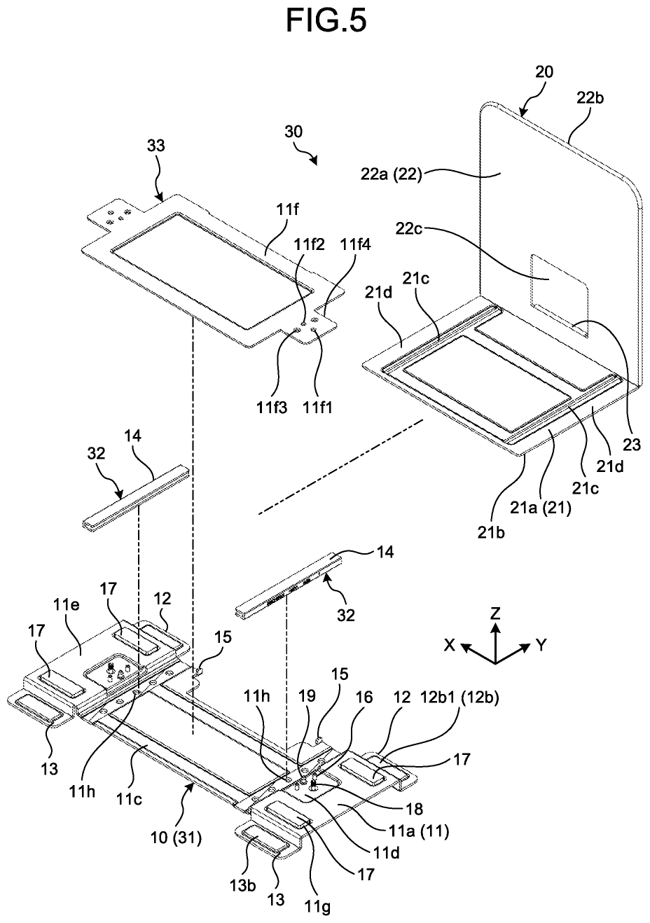

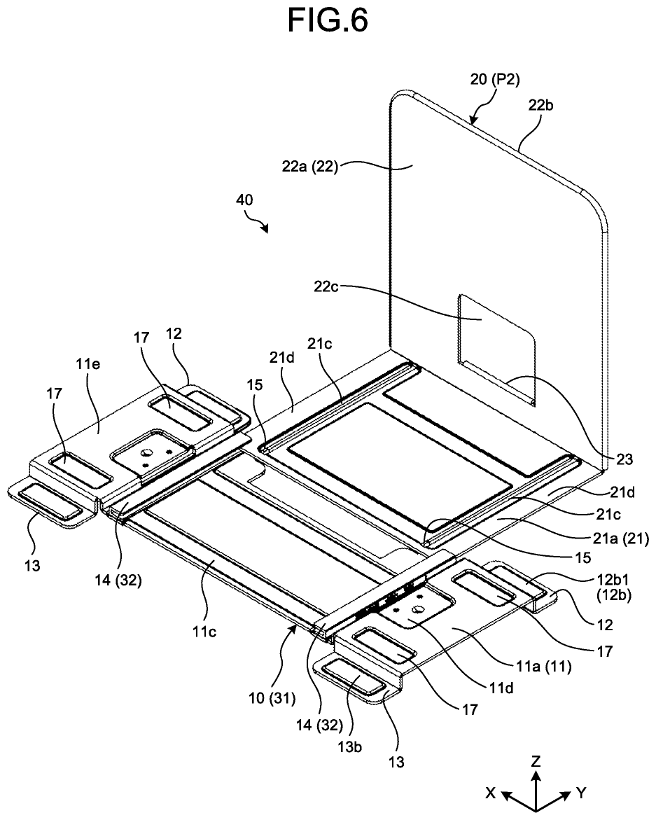

The shelf 20 includes, for example, the bottom wall 21, a sidewall 22, and a leg plate 23. The bottom wall 21 is a rectangular plate extending along the mounting surface 100. The bottom wall 21 is slidably supported by later-described rails 14 (see FIGS. 5 and 6) of the base 10 in the Y-direction with spacing from the mounting surface 100 in the Z-direction. The bottom wall 21 is an exemplary first wall and may be referred to as a transverse wall.

The bottom wall 21 has an upper surface 21a in the Z-direction and a lower surface 21b in the opposite direction of the Z-direction. The lower surface 21b faces the mounting surface 100, and the upper surface 21a faces the storage space 40 (or the object 50, see FIG. 1). In one or more embodiments, the upper surface 21a is more distant from the mounting surface 100 than top surfaces 12b1 of the chambers 12b of the leg plates 12 in the Z-direction. The upper surface 21a is an exemplary first surface, and the top surfaces 12b1 are an exemplary second surface.

As illustrated in FIG. 3, the bottom wall 21 is provided with slits 21c passing through the upper surface 21a and the lower surface 21b in the Z-direction. The slits 21c are located at X-directional, opposite ends 21d of the bottom wall 21 and extend long in the Y-direction. Stoppers 15 (see FIGS. 5 and 6) of the base 10 are inserted into the slits 21c, as later described.

The sidewall 22 is, for example, a rectangular plate extending in the Z-direction from a Y-directional end of the bottom wall 21. In one or more embodiments, in the Z-direction, a length L1 of the sidewall 22 (see FIG. 2) is set to equal to or longer than half a length L2 of the housing 2. The sidewall 22 is an exemplary second wall and may be referred to as an upright wall or a vertical wall.

The sidewall 22 has an outer surface 22b in the Y-direction and an inner surface 22a in the opposite direction of the Y-direction (see FIGS. 1, 3, and 4). The inner surface 22a faces the storage space 40 (the object 50, the left wall 2d) and the outer surface 22b faces oppositely to the storage space 40. The sidewall 22 is provided with an opening 22c passing through the inner surface 22a and the outer surface 22b in the Y-direction.

The leg plate 23 is located at, for example, the periphery of the opening 22c of the sidewall 22. The leg plate 23 protrudes from the periphery of the opening 22c in the opposite direction of the Z-direction and extends in the Y-direction along the mounting surface 100 with spacing from the sidewall 22 in the opposite direction of the Z-direction. In one or more embodiments, while no object 50 is placed on the bottom wall 21, the leg plate 23 is slightly spaced apart from the mounting surface 100 in the Z-direction. With the object 50 placed on the bottom wall 21, the weight of the object 50 causes the bottom wall 21 to bend in the opposite direction of the Z-direction, placing the leg plate 23 in contact with the mounting surface 100. The leg plate 23 is an exemplary fifth wall.

The leg plate 23 includes a protrusion 23a (see FIG. 4) protruding in the opposite direction of the Z-direction. The protrusion 23a is made of elastic material such as elastomer or rubber to prevent the leg plate 23 from being abraded or slipping, for example, which may otherwise occur by contacting the mounting surface 100. The protrusion 23a(elastic member) is accommodated in a chamber 23b (see FIG. 3) of a convex shape protruding from the leg plate 23 in the Z-direction and opening in the opposite direction of the Z-direction.

The stand 30 is, for example, fastened to the bottom wall 2a with the fasteners 18 such as screws or bolts passing through the base 10 in the Z-direction. In one or more embodiments, the bottom wall 11 includes protrusions 19 adjacent to the respective fasteners 18. The protrusions 19 have, for example, a columnar shape following the perimeter of openings 2h (see FIG. 4) of the bottom wall 2a. The protrusions 19 may be referred to as first positioners or engaging pins.

As illustrated in FIG. 4, the bottom wall 2a is provided with central holes 2g and the openings 2h. The central holes 2g are located at, for example, the X-directional ends of the bottom wall 2a. Each central hole 2g is provided with a female screw inside to fit with the male screw of the fastener 18.

The openings 2h are located on the opposite sides of the bottom wall 2a across each central hole 2g in the X-direction, for example. The openings 2h are recesses opening in the opposite direction of the Z-direction, that is, toward the base 10. The protrusions 19 (see FIG. 3) are inserted into the openings 2h closer to the center (inside) in the X-direction. The openings 2h may be referred to as, for example, second positioners.

The stand 30 is positioned by the openings 2h and the protrusions 19 to be attachable to the housing 2 in two postures, a first posture (see FIG. 4) and a second posture different from the first posture. In the first posture (see FIG. 4), the sidewall 22 of the shelf 20 faces the left wall 2d. In the second posture, the sidewall 22 faces the right wall 2f. The location of the openings 2h are not limited thereto, and may be provided closer to the center or inside of the respective central holes 2g in the X-direction alone.

FIG. 5 is an exploded perspective view of the stand 30, and FIG. 6 is a perspective view of part of the stand 30, as seen from an angle different from the angle in FIG. 3. As illustrated in FIGS. 5 and 6, the base 10 of the stand 30 is an assembly of divisible components or parts. Specifically, the base 10 includes, for example, a first component 31, second components 32, and a third component 33.

The first component 31 includes at least a first part 11e serving as part of the bottom wall 11 and the leg plates 12 and 13. In the X-directional center, the first part 11e is provided with a recess 11c depressed in the opposite direction of the Z-direction and opening in the Z-direction. The recess 11c accommodates, for example, the second components 32 (see FIG. 6) as later described, and the bottom wall 21 of the shelf 20. The first component 31 may be referred to as, for example, a main component or a base component.

As illustrated in FIG. 5, the recess 11c is provided at the bottom with a plurality of openings 11h corresponding to the second components 32. The second components 32 include protrusions (not illustrated) protruding in the opposite direction of the Z-direction, and the protrusions are inserted into the openings 11h. In one or more embodiments, for example, by the contact between the periphery of the openings 11h and the protrusions, the second components 32 are restricted from moving along the XY plane relative to the first component 31. The openings 11h may be referred to as third positioners, and the protrusions may be referred to as fourth positioners, for example.

The recess 11c is provided at the bottom with a plurality of stoppers 15 to be inserted into the slits 21c of the bottom wall 21. The stoppers 15 protrude from the Y-directional ends of the recess 11c in the Z-direction. In one or more embodiments, as illustrated in FIG. 6, for example, the stoppers 15 contact the edges of the slits 21c in the opposite direction of the Y-direction to thereby limit the movement of the shelf 20 in the Y-direction relative to the first component 31 (base 10).

The stoppers 15 also contact the edges of the slits 21c in the Y-direction to limit the movement of the shelf 20 in the opposite direction of the Y-direction relative to the first component 31 (base 10). In other words, the shelf 20 is movable in the Y-direction relative to the base 10 within the range of the slits 21c. The slits 21c may be referred to as, for example, tracks. The stoppers 15 and the slits 21c are not limited to such examples. Alternatively, one set of a stopper 15 and a slit 21c may be provided in about the X-directional center, for example.

The second components 32 include at least the rails 14. The rails 14 serve to receive the ends 21d of the bottom wall 21 in the X-direction. The rails 14 have a substantial U-shape opening toward the center (inside) in the X-direction, that is, toward the bottom wall 21, as seen in the Y-direction. The rails 14 slidably support the ends 21d of the bottom wall 21 in the Y-direction. In one or more embodiments, the second components 32 are made of synthetic resin.

The third component 33 (see FIG. 5) includes at least a second part 11f serving as part of the bottom wall 11. The second part 11f covers or closes the recess 11c in the Z-direction, while the second components 32 are accommodated in the recess 11c. This restricts the second components 32 from moving in the Z-direction. The third component 33 may be referred to as, for example, a sub component or a lid. The third component 33 and the first component 31 are made of metal.

Opposite ends 11f4 of the second part 11f in the X-direction are each provided with a plurality of through-holes 11f1 to 11f3 passing in the Z-direction. The fastener 18 is inserted into the through-hole 11f1, and the protrusion 19 is inserted into the through-hole 11f2. A protrusion 16 is inserted into the through-hole 11f3. The protrusion 16 is for use in positioning the third component 33 relative to the first component 31 in the XY plane. The through-holes 11f1 to 11f3 may be referred to as clearance holes.

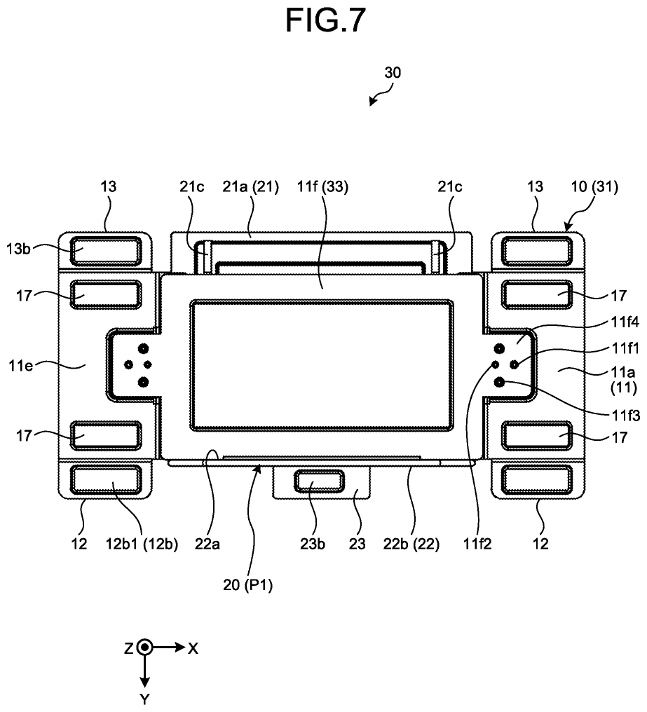

The first part lie is provided with a plurality of recesses lid recessed from the upper surface 11a in the opposite direction of the Z-direction. The recesses 11d can accommodate the X-directional ends 11f4 of the second part 11f. In one or more embodiments, while the recesses 11d accommodate the ends 11f4, that is, the first component 31 and the third component 33 are united together (see FIGS. 3 and 7), the upper surface 11a of the first part lie and the upper surface 11a of the second part 11f are flush with each other in the X-direction.

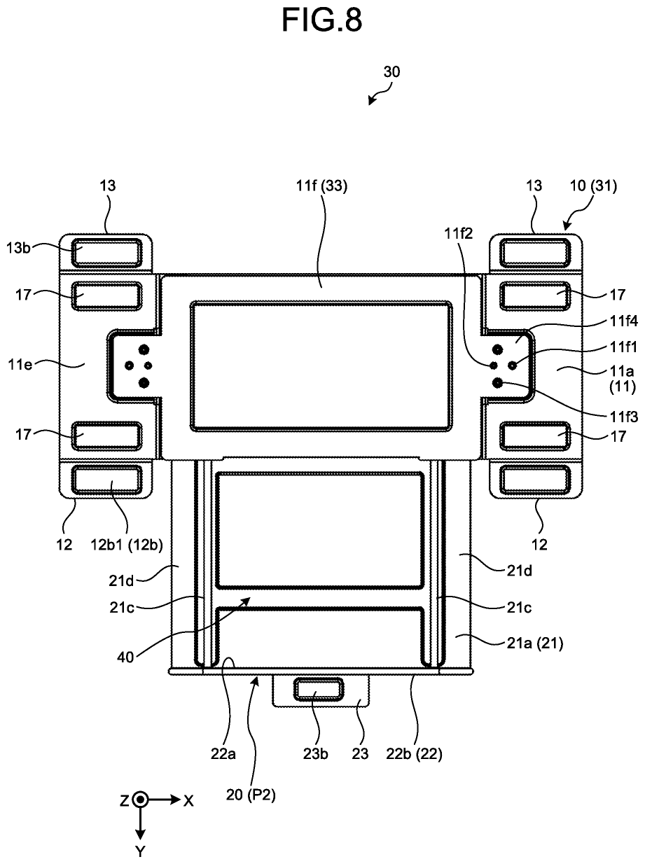

FIG. 7 is a plan view of the stand 30 with the shelf 20 being in a first position P1. FIG. 8 is a plan view of the stand 30 with the shelf 20 being in a second position P2. In one or more embodiments, as illustrated in FIGS. 7 and 8, the shelf 20 is movably supported by the rails 14 of the base 10 between the first position P1 and the second position P2.

In the first position P1 of the shelf 20, the bottom wall 21 is accommodated in the recess 11c (see FIG. 6) and the sidewall 22 is adjacent or close to the bottom wall 11 and the left wall 2d (see FIG. 1) of the housing 2. In the first position P1, the sidewall 22 may be in contact with the left wall 2d or may oppose or be close to the left wall 2d with a gap.

In one or more embodiments, as illustrated in FIG. 7, in the first position P1 of the shelf 20, the end of the bottom wall 21 and the ends of the leg plates 13 in the opposite direction of the Y-direction are flush with each other in the X-direction. This prevents the shelf 20 from protruding in the opposite direction of the Y-direction beyond the base 10.

As illustrated in FIG. 8, in the second position P2 of the shelf 20, the bottom wall 21 protrudes from the recess 11c in the Y-direction and the sidewall 22 is away from the bottom wall 11 and the left wall 2d (see FIG. 1) of the housing 2. This forms the storage space 40 between the left wall 2d and the sidewall 22, to be able to contain the object 50 such as a book or a file.

As described above, the stand 30 according to one or more embodiments includes the base 10 and the shelf 20. The base 10 is attached to the housing 2 of the electronic device 1, extending between the mounting surface 100 and the housing 2. The shelf 20 has the bottom wall 21 (first wall) facing the mounting surface 100, and the sidewall 22 (second wall) extending from the bottom wall 21 in the Z-direction (first direction) crossing the bottom wall 21. The shelf 20 is movably supported by the base 10 between the first position P1 and the second position P2. In the first position P1, the bottom wall 21 is accommodated in the base 10 and the sidewall 22 is adjacent to the housing 2. In the second position P2, the bottom wall 21 protrudes from the first position P1 and the sidewall 22 is away from the housing 2 in the Y-direction (second direction).

During use of the shelf 20, for example, the sidewall 22 in the second position P2 and the housing 2 define the storage space 40 to store or hold the object 50 such as a book or a file. During non-use of the shelf 20, the sidewall 22 can be accommodated in the first position P1 adjacent to the housing 2. This makes it possible to provide the stand 30 that occupies a smaller installation footprint, for example. Moreover, this makes it possible to adjust the width of the storage space 40 in the Y-direction, that is, the amount of protrusion of the sidewall 22 in the Y-direction in the range between the first position P1 and the second position P2 in accordance with an increase or decrease in the volume of the object 50, for example.

In one or more embodiments, the base 10 includes the bottom wall 11 (third wall) that supports the housing 2 with spacing from the mounting surface 100 in the Z-direction; and the leg plates 12 (fourth wall) located in the Y-direction of the bottom wall 11 and being in contact with the mounting surface 100. In the Z-direction the upper surface 21a (first surface) of the bottom wall 21 is more distant from the mounting surface 100 than the top surfaces 12b1 (second surface) of the leg plates 12 are.

This structure can, for example, prevent the top surfaces 12b1 of the base 10 from being located in the storage space 40, which is more distant from the mounting surface 100 than the upper surface 21a is. Thus, this leads to ensuring a sufficient or larger storage space 40 for the object 50. Furthermore, the gap (recess 11c) between the bottom wall 11 and the mounting surface 100 can be effectively used to store the bottom wall 21 of the shelf 20, for example.

In one or more embodiments, the bottom wall 21 is spaced apart from the mounting surface 100 in the Z-direction. The shelf 20 includes the leg plate 23 (fifth wall) that protrudes from the sidewall 22 in the opposite direction of the Z-direction and is able to contact with the mounting surface 100.

Owing to such a structure, by the contact between the leg plate 23 and the mounting surface 100, for example, the bottom wall 21 can more firmly support the object 50 thereon. Furthermore, by the contact between the leg plate 23 and the mounting surface 100, the stand 30 can improve in terms of stability, which leads to preventing the housing 2 of the electronic device 1 from inclining or falling down due to vibration of the housing 2 at the time of occurrence of earthquakes, for example.

In one or more embodiments, with no object 50 placed on the bottom wall 21, the leg plate 23 is spaced apart from the mounting surface 100.

Owing to the spacing between the leg plate 23 and the mounting surface 100, for example, the shelf 20 is more easily or smoothly movable between the first position P1 and the second position P2.

In one or more embodiments, the base 10 includes the rails 14 made of synthetic resin to slidably support the opposite ends 21d of the bottom wall 21 in the X-direction (third direction).

Thus, the synthetic resin rails 14 serve to reduce noise or abrasion occurring between the ends 21d of the bottom wall 21 and the rails 14 when sliding with each other, for example.

In one or more embodiments, the housing 2 has a rectangular-cuboid shape and is longer in length in the Z-direction than in the Y-direction. In the Z-direction the length L1 of the sidewall 22 is equal to or longer than half the length L2 of the housing 2.

Such a sidewall 22 can work to more firmly or stably support or hold the object 50 of a length or height equal to or shorter than the length L2 of the housing 2, for example.

According to one aspect of this disclosure, it is possible to provide an improved stand of a novel structure with less inconvenience.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A stand comprising:
a base that is attached to a housing of an electronic device and extends between a mounting surface and the housing; and
a shelf including:
a first wall facing the mounting surface, and
a second wall extending from the first wall in a first direction crossing the first wall, wherein
the shelf is movably supported by the base between a first position and a second position,
the first position is a position in which the first wall is accommodated in the base and the second wall is adjacent to the housing, and
the second position is a position in which the first wall protrudes from the first position in a second direction crossing the first direction and the second wall is spaced apart from the housing.

2. The stand according to claim 1, wherein
the base includes:
a third wall spaced apart from the mounting surface in the first direction to support the housing, and
a fourth wall located in the second direction of the third wall and being in contact with the mounting surface,
the first wall includes a first surface in the first direction,
the fourth wall includes a second surface in the first direction, and
the first surface is more distant from the mounting surface than the second surface.

3. The stand according to claim 1, wherein
the first wall is spaced apart from the mounting surface in the first direction, and
the shelf includes a fifth wall that protrudes from the first wall or the second wall in an opposite direction of the first direction and that is able to contact with the mounting surface.

4. The stand according to claim 3, wherein
the fifth wall is spaced apart from the mounting surface without any object placed on the first wall.

5. The stand according to claim 1, wherein
the base comprises a rail made of synthetic resin, and
the rail slidably supports opposite ends of the first wall in a third direction crossing the first direction and the second direction.

6. The stand according to claim 1, wherein
the housing has a rectangular-cuboid shape and is longer in length in the first direction than in the second direction, and
in the first direction, the second wall is equal to or longer in length than half a length of the housing.
